(19) United States
(12) Patent Application Publication
(10) Pub. No.: US 2006/0247151 A1
(43) Pub. Date: Nov. 2, 2006

(54) Oxidizing compositions and methods thereof

(76) Inventors: Thomas W. Kaaret, Pleasanton, CA (US); Daniela N. Fritter, Pleasanton, CA (US); Gregory van Buskirk, Pleasanton, CA (US); Michael J. Petrin, Pleasanton, CA (US)

Correspondence Address: THE CLOROX COMPANY, P.O. BOX 24305, OAKLAND, CA, 94623-1305, US

(21) Appl. No.: 11/119,203

(22) Filed: Apr. 29, 2005

(51) Int. Cl. C11D 1/75

(52) U.S. Cl. 510/503

(57) ABSTRACT

Disclosed herein is a viscoelastic oxidizing formulation comprising, in aqueous solution: an effective amount of an oxidizing compound; a thickening system which comprises (i) at least one alkali metal soap and (ii) a hydrotrope selected from the group consisting of amine oxides, betaines and mixtures thereof, each in amounts appropriate to create a viscoelastic composition having a Zero-shear viscosity in the range of 140-265 cP; a Stress ½ value greater than 10 Pa and a Relaxation constant greater than 0.05 second; and a buffer/electrolyte in an amount effective to stabilize the oxidizing compound. The oxidizing formulations may further be formulated to have an oxidant stable opacifier or colorant.

### FIELD OF THE INVENTION

The present invention relates to thickened oxidant compositions, having both viscous and elastic properties, and in particular to thickened bleach compositions which are formulated to pour easily and flow through automatic washer dispensers.

### RELATED ART

U.S. Pat. Nos. 5,104,571A, 4,952,333A, 4,931,207A, and 4,839,077A disclose bleach compositions with suspending agents.

U.S. Pat. Nos. 5,804,545 and 5,348,682 disclose bleach compositions with amine oxides and soap.

U.S. Pat. No. 6,051,676 discloses a bleach composition containing polycarboxylate.

U.S. Pat. Nos. 5,229,027, 5,225,096, and 5,185,096 disclose bleach compositions with iodate.

U.S. Pat. No. 4,839,077 discloses a pourable bleach composition containing a surfactant and a copolymeric thickener.

EP Patent 0,912,696 discloses a bleach-containing ternary surfactant thickener system.

US Patent Application 20030186827 discloses a thick foaming bleach composition.

### SUMMARY OF THE INVENTION

An aspect of the invention includes an oxidizing composition comprising: an effective amount of an oxidizing compound; a thickening system which comprises (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa; and a Relaxation constant greater than 0.05 second; a buffer/electrolyte in an amount effective to stabilize the oxidizing compound; water; and optionally a pigment or opacifier.

Another aspect of the invention includes a bleaching composition comprising: sodium hypochlorite in an amount ranging from 0.01-7%; a thickening system which comprises (i) a lauric acid and (ii) a dimethlyalkylamine oxide having an alkyl group selected from the group consisting of C₈, C₁₀, C₁₂, C₁₄, C₁₆ and mixtures thereof, each in amounts appropriate to create a viscoelastic composition having a Zero-shear viscosity in the range of 140-265 cP, a Stress ½ value greater than 10 Pa and a Relaxation constant greater than 0.05 second; sodium chloride and sodium hydroxide in amounts effective to stabilize the hypochlorite; water; and an opacifier comprising a styrene/acrylate copolymer wherein the percentage of styrene is in the range of greater than 10 and up to 50 percent.

A further aspect of the invention includes a method of preparing a oxidizing composition comprising: a) providing an effective amount of a hypohalite-generating compound; b) providing a thickening system which comprises: (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa and a Relaxation constant greater than 0.05 second; c) providing a buffer/electrolyte in an amount effective to stabilize the hypohalite; d) providing water; e) optionally providing a pigment or opacifier; and f) mixing the materials provided in steps a)-d) and optionally e) together to form a oxidizing composition.

Another aspect of the invention includes a method for treating fabrics with a liquid bleaching composition comprising: a) providing a bleaching composition comprising: an effective amount of a hypochlorite-generating compound; a thickening system which comprises (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa, and a Relaxation constant greater than 0.05 second; a buffer/electrolyte in an amount effective to stabilize the hypochlorite; water; and optionally a pigment or opacifier; contacting the fabrics with the bleaching composition in its neat or diluted form; and washing the fabrics with an aqueous bath comprising water and a conventional laundry detergent before and/or during and/or after the step of contacting the fabrics with the bleaching composition.

A further aspect of the invention includes a method of preparing a oxidizing composition comprising: a) providing an effective amount of a hypohalite-generating compound; b) providing a thickening system which comprises: (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa, and a Relaxation constant greater than 0.05 second; c) providing a buffer/electrolyte in an amount effective to stabilize the hypohalite; d) providing water; e) optionally providing a pigment or opacifier; and f) mixing the materials provided in steps a)-d) and optionally e) together to form a oxidizing composition.

A method for treating fabrics with a liquid bleaching composition comprising: a) providing a bleaching composition comprising: an effective amount of a hypochlorite-generating compound; a thickening system which comprises (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa, and a Relaxation constant greater than 0.05 second; a buffer/electrolyte in an amount effective to stabilize the hypochlorite; water; and optionally a pigment or opacifier; b) contacting said fabrics with said bleaching composition in its neat or diluted form; and c) washing said fabrics with an aqueous bath comprising water and a conventional laundry detergent before and/or during and/or after the step of contacting said fabrics with said bleaching composition.

A further aspect of the invention includes an oxidizing kit comprising: a) providing a bleaching composition comprising: an effective amount of a hypochlorite-generating compound; a thickening system which comprises (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP; a Stress ½ value greater than 10 Pa; and a Relaxation constant greater than 0.05 second; a buffer/electrolyte in an amount effective to stabilize the hypochlorite; water; and optionally a pigment or opacifier; b) providing a bleach-stable dispensing package containing the composition of (a); c) providing instructions on the package to dispense, pour, add (a) from (b) into the bleach dispenser, dispensing device, port, opening, orifice or of an automatic washing machine.

### DEFINITIONS

In this document, use shall be made of the following terms of art, which have the meanings indicated below.

As used herein, the terms “Dispenser” and “Dispensing Device” refer to a portion of an automatic washing machine having an entry port (or opening) for a bleach and/or oxidizing composition to enter and means to dilute and distribute the bleach and/or oxidizing composition into the contents of the washing machine. Said means may include tubing and valves. Typically, a dispenser is contained within the washing machine and all the user sees is the entry port.

“Micelles” as used herein are structures that form spontaneously by the self-association of individual moieties, such as surfactant molecules, in a liquid medium. These molecular aggregates are in equilibrium with monomeric or dissolved—but unassociated—surfactant molecules above a certain concentration for a given surfactant (also known as the critical micellization concentration, or CMC) in a given temperature range. “Normal” micelles are characterized by relatively hydrophobic core regions comprised of lipophilic (hydrophobic) parts of surfactants which avoid contact with water as much as possible, and outer hydrophilic regions formed by lipophobic (hydrophilic) ends of the molecules. Depending on the number of surfactant molecules in the aggregate, micellar shapes can vary from spheres to oblate or prolate ellipsoids, the latter including elongated or rod micelles as well as discs. Rod micelles are also favored, inter alia, by lengthening of alkyl chains. (See, e.g. Smith, U.S. Pat. No. 5,011,538, which is incorporated herein by reference.)

The term “hydrotrope” as used herein includes a surfactant or cosurfactant system that interacts with and modifies the phase behavior of a surfactant micellar system.

The term “Viscoelastic” refers to liquids that exhibit a combination of behavior characterized as both viscous, i.e. liquid-like in that energy is dissipated through the liquid, and elastic, i.e., solid-like in that energy is stored in the fluid. Viscoelastic is used in general association with the oxidizing formulations disclosed herein.

### DETAILED DESCRIPTION

The oxidizing compositions disclosed herein combine both viscous and elastic properties and thus, can be referred to as “viscoelastic”. The viscous component must be sufficiently high to allow for controlled pouring, yet sufficiently low to allow the oxidizing solution to flow easily through the dispenser and be completely used up during the wash cycle, making it unlikely for residue to carry over into the next load of wash. The elastic component holds the solution together so that it will pour easily onto specific areas of clothing and/or into the entry port of a bleach dispenser of an automatic washing machine, with minimal splashing, dripping, or forming messy streamers. The resulting combination provides for a uniform delivery rate of the solution through a washing machine bleach dispenser while still providing the benefit of allowing the user ease of pouring. Additionally, the favorable viscoelastic properties enable a pigment or opacifier to be added to give the user a visual indication of the location of the oxidizing solution.

Before describing embodiments in detail, it is to be understood that the terminology used herein is for the purpose of describing particular embodiments, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. All numerical values, however, inherently contain certain errors necessarily resulting from the standard deviation found in their respective testing measurements.

Rheology

As previously stated, the compositions disclosed herein have elasticities and viscosities that are crucial rheological characterization parameters. Instruments capable of performing oscillatory or controlled stress creep measurements can be used to quantify elasticity. The rheology of the compositions disclosed herein was measured with a Stresstech rheometer at 25° C. in the oscillatory mode and in the viscometry mode, using a concentric cylinder geometry. A frequency sweep with a Stresstech rheometer produces oscillation data which shows the elastic and viscous moduli, G′ and G″, respectively, and the complex viscosity, as a function of frequency. For the viscoelastic compositions disclosed herein, G″ dominates G′ at low frequency, where the system is characterized by the Zero-shear viscosity, the plateau value of the complex viscosity with decreasing frequency. The elasticity increases in relative importance with increasing frequency, which can be seen by the faster growth of G′ vs. G″ and finally a “cross-over” to a region where G′ dominates G″ at higher frequency. The onset of elasticity in these systems is quantified as the frequency at which G′ crosses G″, or more conveniently, as the inverse of this quantity, called the Relaxation constant, which has units of time. Liquids within the specified range of Zero-shear viscosity but having Relaxation constants less than 0.05 second are gooey or syrupy. Thus, those skilled in the art will recognize that in order to have the desired pourability, it is necessary that the Relaxation constant be greater than 0.05 second.

In viscometry mode, the sample is sheared in a continuous rotational motion. Measurements of shear viscosity are made as a function of shear stress, in which the data are collected at each value of shear stress after the flow field has reached equilibrium and the viscosity has reached its steady-state value. The flow behavior of the viscoelastic compositions of interest fit well to the Ellis model, given by:
Shear viscosity=Vo/[1+(shear stress/Stress ½)^{(α-1)}],
Where Vo, Stress ½, and a are adjustable parameters. Here, Vo corresponds to the Zero-shear viscosity, Stress ½ refers to the value of the shear stress at which the shear viscosity has dropped to half the Zero-shear viscosity, and α is related to the degree of shear-thinning (how quickly the viscosity drops as a function of stress in the shear-thinning region). Without being bound by theory, it is believed that high values of Stress ½, which are associated with more Newtonian or fluid-like flow, are beneficial to maintaining a smoother flow through constrictions, unimpeded by the flow instabilities and normal forces associated with more elastic fluids. Thus, those skilled in the art will realize that, for compositions within the specified range of Zero-shear viscosity, Stress ½ values greater than 10 Pa are desirable for use with automatic washing machine dispensers. Without being bound by theory, it is further believed that this combination of rheological parameters defines a unique phase space encompassing the inventive compositions herein, wherein the phase space exhibits the novel ability to stably suspend fine particulates, such as for example, opacifiers and pigments over extended time, and yet provide for controllable pouring and favorable automatic washing machine dispensing characteristics. Embodiments of inventive compositions within the phase space defined by Zero-shear viscosity in the range of 140-265 cP, a Stress ½ value greater than 10 Pa; and a Relaxation constant greater than 0.05 second are capable of suspending fine particulates for extended storage times without precipitation or phase separation, yet exhibit excellent pourability when dispensed using an oxidizing kit employing a bleach-stable dispensing package, and further exhibit favorable flow characteristics, e.g. are “not too thick” to flow within an automatic washing machine dispensing apparatus which generally offers restrictions to flow as they are designed by manufacturers to dispense “water thin” liquids such as conventional bleaching compositions common to the art.

Embodiments disclosed herein have Zero-shear viscosities ranging from 140-265 centipoise (cP), Stress ½ values greater than 10 Pascals (Pa) and elasticity's as measured either by Cross-over frequency of less than 20 Hz., or, equivalently, Relaxation constant of greater than 0.05 seconds.

Furthermore, the oxidizing compositions disclosed herein are liquid-gels that provide stable, slightly thickened, free-flowing consistencies which do not rely on expensive thickening additives but, instead, exploit the viscosity-enhancing attributes of surfactants and/or hydrotropes. A liquid-gel as used herein is defined as a colloid comprising a continuous phase, which is mostly water, in which a dispersed phase, which contains the actives, is dispersed in a manner such as to provide a slightly thickened, free-flowing product. The liquid-gel is translucent to transparent and may also be opalescent. The liquid-gel is a favorable physical state for an oxidizing composition used to pretreat stained clothing or used in conjunction with a bleach dispenser of an automatic washing machine. Since the liquid-gel will be less fluid, or mobile, than regular liquid bleach, it is less likely to result in overdosing and/or spillage. The liquid-gel is also an attractive medium because it can be colored, or tinted, with, an oxidant-stable dye, colorant, pigment or opacifier. Additionally, if the oxidizing compositions disclosed herein are combined with certain dyes, pigments and/or opacifiers, they can be packaged in transparent to translucent packages (e.g., transparent plastic bottles) since the suspendable materials prevent visible and ultraviolet wavelength light-mediated degradation.

In one embodiment, a liquid-gel oxidizing composition comprises: an effective amount of a hypohalite-generating compound; a thickening system which comprises (i) at least one alkali metal soap, e.g., a lauric acid and (ii) a hydrotrope, e.g., an amine oxide, each in amounts appropriate to create a viscoelastic composition having a Zero-shear viscosity in the range of 140-265 cP, a Stress ½ greater than 10 Pa and a Relaxation constant greater than 0.05 seconds as measured at 25° C.; a buffer/electrolyte in an amount effective to stabilize the hypohalite; and water.

The individual constituents of various embodiments are described more particularly below. As used herein, all percentages are weight percentages of actives, unless otherwise specified. Additionally, the term “effective amount” means an amount sufficient to accomplish the intended purpose, e.g., thickening, suspending, cleaning, etc.

In addition to the above listed constituents, the thickened oxidizing compositions disclosed herein may optionally include fragrances, pigments, coloring agents, opacifying agents, whiteners, solvents, chelating agents and/or builders, some of which are discussed in detail below.

Oxidizing Compounds

Any oxidizing agent and/or bleach known to those skilled in the art may be suitable to be used herein including any peroxygen bleach as well as a halogen bleach and/or halogen bleach releasing component capable of generating an oxidizing agent in aqueous solution. The source of the oxidizing agent according to the present invention acts as a bleach in that it increases the ability of the compositions to remove colored stains, organic stains and soils, produce whitening effect on fibers in general, acts to destroy malodorous molecules, and further kills or reduces the levels of germs, bacteria, viruses and other microorganisms during use.

According to the present invention, the oxidizing agent may be a halogen bleach. In one embodiment, the oxidizing agent is a halogen bleach source which may be selected from various hypohalite-producing species, for example, bleaches selected from the group consisting of the alkali metal and alkaline earth salts of hypohalite, haloamines, haloimines, haloimides and haloamides. All of these are believed to produce hypohalous bleaching species in situ.

The oxidizing agent may be a hypohalite or a hypohalite generator capable of generating hypohalous bleaching species. Hereafter, the term “hypohalite” is used to describe both a hypohalite or a hypohalite generator, unless otherwise indicated. In one embodiment, the hypohalite oxidizing agent is a hypochlorite or a generator of hypochlorite in aqueous solution, although hypobromite or a hypobromite generator is also suitable. Representative hypochlorite generators include sodium, potassium, lithium, magnesium and calcium hypochlorite, chlorinated trisodium phosphate dodecahydrate, potassium and sodium dichloroisocyanurate and trichlorocyanuric acid. Organic bleach sources suitable for use include heterocyclic N-bromo and N-chloro imides such as trichlorocyanuric and tribromocyanuric acid, dibromocyanuric acid and dichlorocyanuric acid, and potassium and sodium salts thereof, N-brominated and N-chlorinated succinimide, malonimide, phthalimide and naphthalimide. Also suitable are hydantoins, such as dibromodimethyl-hydantoin and dichlorodimethyl-hydantoin, chlorodimethylhydantoin, N-chlorosulfamide (haloamide) and chloramine (haloamine).

In another embodiment, the hypohalite oxidizing agent is an alkali metal hypochlorite, an alkaline earth salt of hypochlorite, or a mixture thereof. A particularly effective oxidizing agent that may be employed in one embodiment is sodium hypochlorite, having the chemical formula NaOCl.

According to the present invention, the oxidizing agent may be an oxygen bleach, including a peroxygen, peroxyhydrate or active oxygen generating compound. Suitable peroxygen bleaches for use herein include hydrogen peroxide or sources thereof. As used herein a source of hydrogen peroxide refers to any compound which generates active oxygen when said compound is in contact with water. Suitable water-soluble sources of hydrogen peroxide for use herein include percarbonates, preformed percarboxylic acids, persilicates, persulphates, perborates, organic and inorganic peroxides and/or hydroperoxides.

In one embodiment, hydrogen peroxide is employed in the aqueous composition of the present invention. The compositions of the present invention that comprise a peroxygen bleach may further comprise a bleach activator or mixtures thereof. By “bleach activator”, it is meant herein a compound which reacts with peroxygen bleach like hydrogen peroxide to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS). Also suitable are N-acyl caprolactams selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmental-friendly as it eventually degrades into citric acid and alcohol. Furthermore, acetyl triethyl citrate has a good hydrolytical stability in the product upon storage and it is an efficient bleach activator. A particular family of bleach activators also of interest was disclosed in U.S. Pat. Nos. 5,741,437, 6,010,994 and 6,046,150, generally described as n-alkyl alkyl ammonium acetonitrile activators, and particularly preferred in that family is n-methyl morpholinium acetonitrile (MMA).

In addition, other classes of peroxides can be used as an alternative to hydrogen peroxide and sources thereof or in combination with hydrogen peroxide and sources thereof. Suitable classes include dialkylperoxides, diacylperoxide, performed percarboxylic acids, organic and inorganic peroxides and/or hydroperoxides. Suitable organic peroxides/hydroperoxides include diacyl and dialkyl peroxides/hydroperoxides such as dibenzoyl peroxide, t-butyl hydroperoxide, dilauroyl peroxide, dicumyl peroxide, and mixtures thereof. Suitable preformed peroxyacids for use in the compositions according to the present invention include diperoxydodecandioic acid DPDA, magnesium perphthalic acid, perlauric acid, perbenzoic acid, diperoxyazelaic acid and mixtures thereof.

Persulfate salts, or mixtures thereof, are alternative sources of active oxygen that may be used in the compositions according to the present invention. In one embodiment, a persulfate salt can be used herein in the form of the monopersulfate triple salt. One example of monopersulfate salt commercially available is potassium monopersulfate commercialized by Peroxide Chemie GMBH under the trade name Curox®, by Degussa under the trade name Caroat and from Du Pont under the trade name Oxone. Other persulfate salts such as dipersulfate salts commercially available from Peroxide Chemie GMBH can be used in the compositions according to the present invention.

In embodiments employing a solid oxidizing agent and/or solid bleaching component, the material is preferably employed in the form of a finely divided particulate having a particle size, and/or average particle size distribution, that is sufficiently small to enable suspension in the aqueous composition with a minimum of settling or precipitation. In an alternative embodiment employing a particulate source of oxidizing agent, the agent is coated and/or encapsulated according to any known methods and materials in the art to prevent and/or retard dissolution of the agent in the aqueous compositions during storage, such encapsulation means and materials selected, however, so as to provide release of the oxidizing agent upon dilution of the compositions into a larger volume of water, such as for example, during dilution into a washing machine during use. In embodiments employing a plurality of oxidizing agents, or combinations of oxidizing agents, secondary oxidizing agents and/or oxidizing agents and/or activators, the materials may be present as separately dispersed particulate components, optionally coated and/or encapsulated, or alternatively present in the form of coated and/or encapsulated core agglomerate of the various agents, such coating or encapsulating material acting to prevent or retard water penetration into the core agglomerate under storage conditions, but providing release as described hereinbefore.

In a further embodiment, both a source of water soluble oxidizing agent and a particulate oxidizing agent are combined so as to provide a composition according to the present invention having immediate bleaching strength combined with a reserve bleaching strength when the compositions are diluted for use.

In yet further embodiments, only a low water solubility oxidizing agent, or alternatively a coated and/or encapsulated oxidizing agent, are employed in the inventive compositions so as to provide minimal or no bleaching effect, for example providing a composition that will not damage or over bleach a susceptible fabric or dye even upon (improper) direct application, such compositions however being capable of releasing the oxidizing agent when the composition is properly diluted for use, such as in a washing machine, where the diluted level of the oxidizing agent will not damage the fabric or dye.

Hypochlorite Bleach Compounds

Hypochlorite is particularly applicable to the present invention so much of the discussion will include hypochlorite. However, it should be kept in mind that other hypohalite-generating sources could be substituted wherever hypochlorite is used.

Hypochlorite is an oxidant chemical that provides good stain and soil removal and is additionally a broad spectrum antimicrobial agent. The hypochlorite bleach source may be selected from various hypochlorite-producing species, for example, bleaches selected from the group consisting of the alkali metal and alkaline earth salts of hypohalite, haloamines, haloimines, haloimides and haloamides. All of these are believed to produce hypohalous bleaching species in situ. Hypochlorite and compounds producing hypochlorite in aqueous solution are preferred, although hypobromite may also be suitable. Representative hypochlorite-producing compounds include sodium, potassium, lithium and calcium hypochlorite, chlorinated trisodium phosphate dodecahydrate, potassium and sodium dicholoroisocyanurate and trichlorocyanuric acid. Organic bleach sources suitable for use include heterocyclic N-bromo and N-chloro imides such as trichlorocyanuric and tribromocyanuric acid, dibromo and dichlorocyanuric acid, and potassium and sodium salts thereof, N-brominated and N-chlorinated succinimide, malonimide, phthalimide and naphthalimide. Also potentially suitable are hydantoins, such as dibromo and dichlorodimethylhydantoin, chlorobromo-dimethylhydantoin, N-chlorosulfamide (haloamide) and chloramine (haloamine). Particularly preferred are alkali metal hypochlorites, namely, sodium, potassium and lithium hypochlorite, and mixtures thereof.

It is possible to use an alkali metal hypochlorite bleach which has a relatively low salt content. For example, hypochlorite bleaches are commonly formed by bubbling chlorine gas through liquid sodium hydroxide or corresponding metal hydroxide to result in formation of the corresponding hypochlorite, along with the co-formation of a salt such as sodium chloride. In other contexts, it has been found desirable to use hypochlorites formed for example by reaction of hypochlorous acid with alkali metal hydroxide in order to produce the corresponding hypochlorite with water as the only substantial by-product. Hypochlorite bleach produced in this manner is referred to as “high purity, high strength” bleach, or also, as “low salt, high purity” bleach, and is available from a number of sources, for example Olin Corporation which produces hypochlorite bleach as a 30% solution in water. The resulting solution could then be diluted to produce the hypochlorite strength suitable for use in the embodiments disclosed herein.

The hypochlorite may be formed with other alkaline metals as are well known to those skilled in the art. Although the term “hypochlorite” is employed herein, it is not intended to limit the invention only to the use of chloride compounds but is also intended to include other halides or halites, as discussed above.

The hypochlorite and any salt present within the composition can be a source of ionic strength for the composition, although the buffer/electrolyte also plays a significant role. The ionic strength of the composition may also have an effect on thickening.

In one embodiment, the hypochlorite is present in an amount ranging from about 0.01 weight percent to about 7 weight percent. In another embodiment, the hypochlorite is present in an amount ranging from about 1 weight percent to about 4 weight percent.

Thickening System

As disclosed above, the thickening in the invention is mediated by a system which comprises a mixture of two or more surfactants and/or hydrotropes. One example includes: a system comprising: (i) at least one alkali metal soap and (ii) a hydrotrope selected from the group consisting of trialkylamine oxides, betaines and mixtures thereof; each in amounts appropriate to create a slightly thickened composition.

Alkali Metal Soap

The first component of the thickening system is an alkali metal soap (alkyl carboxylates). The soaps utilized are typically formed in situ, by using the appropriate carboxylic acid (e.g., a C₆₋₁₈ carboxylic acid, such as, without limitation, lauric, stearic, myristic acids, and unsaturated acids, such as coco fatty acid), and neutralizing with e.g., sodium hydroxide (NaOH). Other alkali metal hydroxides, such as potassium and lithium hydroxides, can be utilized. Commercial sources of these fatty acids include Henkel Corporation's Emery Division. The soap is present in an amount of about 0.1 to 10%. In one embodiment, the soap is present in an amount of about 0.5-1.5% by weight.

It may be possible to add, as a co-surfactant, alkali metal alkyl sulfates, alkyl aryl sulfonates, primary and secondary alkane sulfonates (SAS, also referred to as paraffin sulfonates), alkyl diphenyl ether disulfonates, and mixtures thereof. These latter anionic surfactants will preferably have alkyl groups averaging about 8 to 20 carbon atoms. Further, alkali metal salts of alkyl aryl sulfonic acids might be useful, such as linear alkyl benzene sulfonates, known as LAS's. Typical LAS's have C₈₋₁₆ alkyl groups, examples of which include Stepan Chemical Company's BIOSOFT®, and CALSOFT® manufactured by Pilot Chemical Company. Still further potentially suitable cosurfactants include the alkyl diphenyl ether disulfonates, such as those sold by Dow Chemical Company under the name “Dowfax,” e.g., Dowfax 3B2. Other potentially suitable anionic cosurfactants include alkali metal alkyl sulfates such as Conco Sulfate WR, sold by Continental Chemical Company, which has an alkyl group of about 16 carbon atoms; and secondary alkane sulfonates such as HOSTAPUR SAS, manufactured by Farbwerke Hoechst A.G., Frankfurt, Germany.

2. Hydrotropes

Hydrotropes include amine oxides, and specifically trialkyl amine oxides, as represented below. 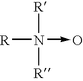
Additionally, it may be suitable to use mono-short chain C₁₋₄ alkyl, di-long chain C ₁₀₋₂₀ alkyl amine oxides. In the structure above, R′ and R″ can be alkyl of 1 to 3 carbon atoms, and are most preferably methyl, and R is alkyl of about 10 to 20 carbon atoms. When R′ and R″ are both methyl and R is alkyl averaging about 12 carbon atoms, the structure for dimethyldodecylamine oxide is obtained. Other amine oxides include the C₁₄ alkyl (tetradecyl) and C₁₆ (hexadecyl) amine oxides. It is acceptable to use mixtures of any of the foregoing. In general, it has been found that the longer alkyl group results in reduced skin sensitivity, while the shorter alkyl group appears to contribute to better cleaning performance. Representative examples of these particular type of bleach-stable nonionic surfactants include the dimethyldodecylamine oxides sold under the trademarks AMMONYX® LO and CO by Stepan Chemical. Yet other amine oxides are those sold under the trademark BARLOX® by Lonza, Conco XA sold by Continental Chemical Company, AROMAX™ sold by Akzo, and SCHERCAMOX™ sold by Scher Brothers, Inc. These amine oxides have main alkyl chain groups averaging about 10 to 20 carbon atoms.

Betaines and their derivatives, especially C₁₀₋₂₀ betaines, also appear to be useful hydrotropes in the compositions disclosed herein. This definition includes both alkylbetaines, sulfoalkylbetaines and mixtures thereof. Betaines such as those described in the patents to Choy et al., U.S. Pat. Nos. 4,599,186, 4,657,692 and 4,695,394, all of common assignment herewith and the disclosures of which are incorporated herein by reference, are effective.

It may also be beneficial to include mixtures of such amine oxides and betaines.

The hydrotrope is present in a range of, generally about 0.1 to 10% by weight. In one embodiment, the hydrotrope is present in the range of about 0.75 to 2% by weight.

The ratio of the hydrotrope, e.g., amine oxide, to alkali metal soap effects the viscoelastic parameters of the resulting compositions. In various embodiments, this ratio ranges from 0.8:1 to 3:1. In specific embodiments described below, the ratio of amine oxide to alkali metal soap is 1.5:1. Without being bound by any particular theory, it is believed that the addition of a coco fatty acid promotes the formation of elongated rod-like micelles with the amine oxide. These micelles can form a network which results in efficient thickening. It has thus surprisingly been found that the desired viscoelastic properties as defined herein are most successfully obtained at the above-mentioned range of amine oxide to alkali metal soap ratio.

Buffers/Electrolytes

pH adjusting agents may be added to adjust the pH, and/or buffers may act to maintain pH. In this instance, alkaline pH is favored for purposes of both rheology and cleaning effectiveness. Additionally, a high pH is important for maintaining hypochlorite stability. Examples of buffers include the alkali metal silicates, metasilicates, polysilicates, carbonates, bicarbonates, sesquicarbonates, hydroxides, orthophosphates, metaphosphates, pyrophosphates, polyphosphates and mixtures of the same. Certain organic buffers also appear suitable (although may require an additional ionizable compound), such as polyacrylates, and the like. Control of pH may be necessary to maintain the stability of a hypochlorite source and to avoid protonating the amine oxide. For the latter purpose, the pH should be maintained above the pKa of the amine oxide. Where the active halogen source is sodium hypochlorite, the pH is maintained above about pH 10.5, preferably above or about pH 11. Most preferred for this purpose are the alkali metal hydroxides, especially sodium, potassium, or lithium hydroxide. The total amount of pH adjusting agent/buffer including that inherently present with bleach plus any added, can vary from about 0.1% to 15%, preferably from about 0.1-10%.

Water

It should be briefly noted that the main ingredient of the oxidizing compositions disclosed herein is water, preferably softened, distilled or deionized water. Water provides the continuous liquid phase into which the other ingredients are added to be dissolved/dispersed. The amount of water present generally exceeds 30% and can be as high as 99.9%, although generally, it is present in a quantity sufficient (q.s.) to provide the appropriate viscoelastic characteristics desired.

Optional Ingredients

The composition of the present invention can be formulated to include such components as fragrances, coloring and/or opacifying agents, whiteners, solvents, chelating agents and builders, which enhance performance, stability or aesthetic appeal of the composition. From about 0.01% to about 2% of a fragrance such as those commercially available from International Flavors and Fragrance, Inc. may be included. Examples of embodiments disclosed herein contain 0.1% fragrance. Dyes and pigments may be included in small amounts. For example, Ultramarine Blue (UMB) and copper phthalocyanines are examples of widely used bleach stable pigments which may be incorporated in the compositions disclosed herein. Opacifiers such as an acrylate polymer or a styrene/acrylate co-polymer may also be incorporated in the compositions disclosed herein. In one embodiment a 50/50 styrene/acrylate co-polymer (Alco Guard 7100, Alco Chemical, Chattanooga, Tenn.) is used as the opacifier. Embodiments using the 50/50 styrene/acrylate copolymer exhibited increased phase stability compared to a 10/90 styrene/acrylate copolymer or an acrylate polymer under conditions of high ionic strength or in the presence of fragrance.

Experimental

The following examples illustrate embodiments of the oxidizing compositions described herein. Table 1 contains the formulations of samples A-D given by weight percent. Table 2 shows the rheological data for samples A-D as compared to several commercial products. All measurements were conducted at 25° C.

TABLE 1

| Components | Sample A | Sample B | Sample C | Sample D |
|---|---|---|---|---|
| Sodium Hypochlorite (NaOCl) | 1.4% | 2.4% | 3.4% | 2.4% |
| Sodium Chloride (NaCl)¹ | 1.1% | 1.9% | 2.7% | 1.9% |
| Sodium Hydroxide (NaOH) | 0.9% | 0.9% | 0.9% | 0.9% |
| (C₈-C₁₄) Coco Fatty Acid² | 1% | 0.8% | 0.6% | 0.73 |
| (C₈-C₁₄) amine oxide³ | 1.7% | 1.4% | 1% | 1.08 |
| Styrene/Acrylic polymer (90/10) | 0.16% | 0.16% | 0.16% | 0.16% |
| Potassium Iodide (KI) | 0.002% | 0.002% | 0.002% | 0.002% |
| 1-(3-chloroallyl1)-3,5,7-triana-1- | 0.0005% | 0.0005% | 0.0005% | 0.0005% |
| azoniaadiamaritane chloride | | | | |
| Sodium Carbonate (NaCO₃) | 0.06% | 0.06% | 0.06% | 0.06% |
| Water | balance | balance | balance | Balance |

¹NaCl and NaOCl are equimolar in concentration
²C₁₂ coco fatty acid, Emery Coconut Fatty Acid
³C₁₂ amine oxide, Ammonyx Lauramine Oxide

TABLE 2

| | Zero-shear | Cross-over | Relaxation | Stress |
|---|---|---|---|---|
| Sample | viscosity (cP) | frequency (Hz) | constant (s)* | ½ (Pa) |
| Sample A | 145 | 8.1 | 0.123 | 25 |
| Sample B | 260 | 10 | 0.1 | 22 |
| Sample C | 270 | 6.6 | 0.152 | 18 |
| Sample D | 190 | 10 | 0.1 | 18 |
| ACE | 160 | 4 | 0.25 | 6.5 |
| eucalyptus | | | | |
| Neutrex Futura | 200 | 5.2 | 0.192 | 6 |
| Suave | | | | |
| ACE citrus | 220 | 3.9 | 0.256 | 7.5 |
| Clorox Cleanup | 290 | 7.8 | 0.128 | 27 |
| Gel | | | | |
| Neutrex Futura | 330 | 3.4 | 0.294 | 6.5 |
| Verde | | | | |
| ACE | 370 | 3.9 | 0.256 | 8 |
| protección | | | | |
| ACE Hogar | 380 | 3.2 | 0.313 | 8 |
| Woolite | 300 | 50 | 0.02 | 520 |
| Professional | 2,700 | 0.035 | 28.571 | 0.6 |
| Strength Liquid | | | | |
| Plumber | | | | |

*Relaxation constant is the inverse of frequency in HZ at cross-over of G′, G″

1. An oxidizing composition comprising:
a) an effective amount of an oxidizing compound;
b) a thickening system which comprises (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa; and a Relaxation constant greater than 0.05 second;
c) a buffer/electrolyte in an amount effective to stabilize the oxidizing compound;
d) water; and
e) optionally a pigment or opacifier.

2. The oxidizing composition of claim 1 wherein said hydrotrope is a trialkyl amine oxide.

3. The oxidizing composition of claim 1 wherein said alkali metal soap comprises a neutralized C₆₋₁₈ carboxylic acid.

4. The oxidizing composition of claim 3 wherein said C₆₋₁₈ carboxylic acid is neutralized in situ.

5. The oxidizing composition of claim 3 wherein said C₆₋₁₈ carboxylic acid is a lauric acid.

6. The oxidizing composition of claim 2 wherein said trialkyl amine oxide is a dimethyl dodecylamine oxide, a C₈₋₁₆ amine oxide or mixtures thereof.

7. The oxidizing composition of claim 1 wherein the oxidizing compound is a hypohalite generating compound.

8. The oxidizing composition of claim 7 wherein the hypohalite-generating compound is sodium, potassium or lithium hypochlorite and mixtures thereof.

9. The oxidizing composition of claim 7 wherein the hypohalite-generating compound is sodium hypochlorite.

10. The oxidizing composition of claim 1 wherein the buffer/electrolyte is selected from the group consisting of alkali metal silicates, metasilicates, polysilicates, carbonates, bicarbonates, sesquicarbonates, hydroxides, orthophosphates, metaphosphates, pyrophosphates, polyphosphates and mixtures thereof.

11. The oxidizing composition of claim 9 wherein the buffer/electrolyte is a mixture of sodium hydroxide and sodium chloride.

12. The oxidizing composition of claim 1 wherein said opacifier is a 90/10 styrene/acrylate copolymer.

13. The oxidizing composition of claim 1 wherein said opacifier is a 50/50 styrene/acrylate copolymer.

14. A bleaching composition comprising:
a) sodium hypochlorite in an amount ranging from 0.01-7%;
b) a thickening system which comprises (i) a C₆₋₁₈ carboxylic acid and (ii) a dimethlyalkylamine oxide having an alkyl group selected from the group consisting of C₈, C₁₀, C₁₂, C₁₄, C₁₆ and mixtures thereof, each in amounts appropriate to create a viscoelastic composition having a Zero-shear viscosity in the range of 140-265 cP, a Stress ½ value greater than 10 Pa and a Relaxation constant greater than 0.05 second;
c) sodium chloride and sodium hydroxide in amounts effective to stabilize the hypochlorite and neutralize the carboxylic acid;
d) water; and
e) an opacifier comprising a styrene/acrylate copolymer wherein the percentage of styrene is in the range of greater than 10 and up to 50 percent.

15. A method for treating fabrics with a liquid bleaching composition comprising:
a) providing a bleaching composition comprising: an effective amount of a hypochlorite-generating compound; a thickening system which comprises (i) at least one alkali metal soap and (ii) a hydrotrope selected from the group consisting of trialkylamine oxides, betaines and mixtures thereof, each in amounts appropriate to create a viscoelastic composition having a Zero-shear viscosity in the range of 140-265 cP, a Stress ½ value greater than 10 Pa, and a Relaxation constant greater than 0.05 second; a buffer/electrolyte in an amount effective to stabilize the hypochlorite; water; and optionally a pigment or opacifier;
b) contacting said fabrics with said bleaching composition in its neat or diluted form; and
c) washing said fabrics with an aqueous bath comprising water and a conventional laundry detergent before and/or during and/or after the step of contacting said fabrics with said bleaching composition.
